(19) United States
(12) Patent Application Publication
(10) Pub. No.: US 2025/0165933 A1
(43) Pub. Date: May 22, 2025

(54) INDUSTRIAL MACHINE MAINTENANCE MANAGEMENT DEVICE AND PRODUCTION SYSTEM

(71) Applicant: FANUC CORPORATION, Yamanashi (JP)

(72) Inventor: Shinji KURIHARA, Yamanashi (JP)

(73) Assignee: FANUC CORPORATION, Yamanashi (JP)

(21) Appl. No.: 18/839,286

(22) PCT Filed: May 13, 2022
(86) PCT No.: PCT/JP2022/020209

§ 371 Date: Aug. 16, 2024

(51) Int. Cl. G06Q 10/20; G06Q 10/087

(52) U.S. Cl. CPC G06Q 10/20; G06Q 10/087

(57) ABSTRACT

The present invention provides an industrial machine maintenance management device that enables maintenance management of industrial machines with consideration to the inventory status of replacement components. The industrial machine maintenance management device manages maintenance of a plurality of industrial machines and comprises: an operation information acquisition unit that acquires operation information pertaining to the plurality of industrial machines; a failure prediction unit that predicts failure-predicted components, which are predicted to fail among components of the plurality of industrial machines, and failure prediction times thereof on the basis of the acquired operation information; an inventory information acquisition unit that acquires inventory information pertaining to inventory and procurement of replacement components of the components of the plurality of industrial machines; and a maintenance priority order determination unit that determines a maintenance priority order for the failure-predicted components of the plurality of industrial machines on the basis of the predicted failure prediction times of the failure-predicted components and the acquired inventory information pertaining to the replacement components.

### TECHNICAL FIELD

The present invention relates to a maintenance management device and a production system for industrial machines.

### BACKGROUND ART

In a production system including a plurality of industrial machines, the failure of one industrial machine may cause the production system to stop for a long time. In this case, considerable damage occurs. To avoid such a situation, there is known a technique of predicting failure of an industrial machine in advance and performing maintenance management (preventive maintenance) so as to perform maintenance (maintenance, preventive maintenance) in advance, such as replacement of a component that is predicted to fail (for example, see Patent Document 1).

### CITATION LIST

### Patent Document

Patent Document 1: Japanese Unexamined Patent Application, Publication No. 2006-285884

### DISCLOSURE OF THE INVENTION

### Problems to be Solved by the Invention

However, when a replacement component is not in stock and the lead time (time from order to delivery) for procurement of the replacement component is long, the failure-predicted component may fail before maintenance. Therefore, it is desired to perform maintenance management of the industrial machine in consideration of the inventory status of the replacement component.

### Means for Solving the Problems

A maintenance management device for industrial machines of the present disclosure is a maintenance management device for managing maintenance of a plurality of industrial machines. The maintenance management device includes an operation information acquisition unit configured to acquire operation information of the plurality of industrial machines; a failure prediction unit configured to predict a failure-predicted component, which is predicted to fail among components of the plurality of industrial machines, and a predicted failure time of the failure-predicted component based on the acquired operation information; an inventory information acquisition unit configured to acquire inventory information regarding inventory and procurement of replacement components for the components of the plurality of industrial machines; and a maintenance priority order determination unit configured to determine a maintenance priority order of the failure-predicted component of the plurality of industrial machines based on the predicted failure time of the failure-predicted component and the acquired inventory information of the replacement components.

A production system of the present disclosure includes a plurality of industrial machines; the maintenance management device for industrial machines described above; and an inventory management device configured to manage inventory and procurement of replacement components for components of the plurality of industrial machines.

### Effects of the Invention

According to the present disclosure, it is possible to perform maintenance management of an industrial machine in consideration of the inventory status of a replacement component.

### BRIEF DESCRIPTION OF THE DRAWINGS

FIG. 1 shows an example of a production system including a maintenance management device for industrial machines according to the present embodiment.

### PREFERRED MODE FOR CARRYING OUT THE INVENTION

Hereinafter, an embodiment of the present invention will be described with reference to the accompanying drawing. In the drawings, the same or corresponding portions are denoted by the same reference numerals.

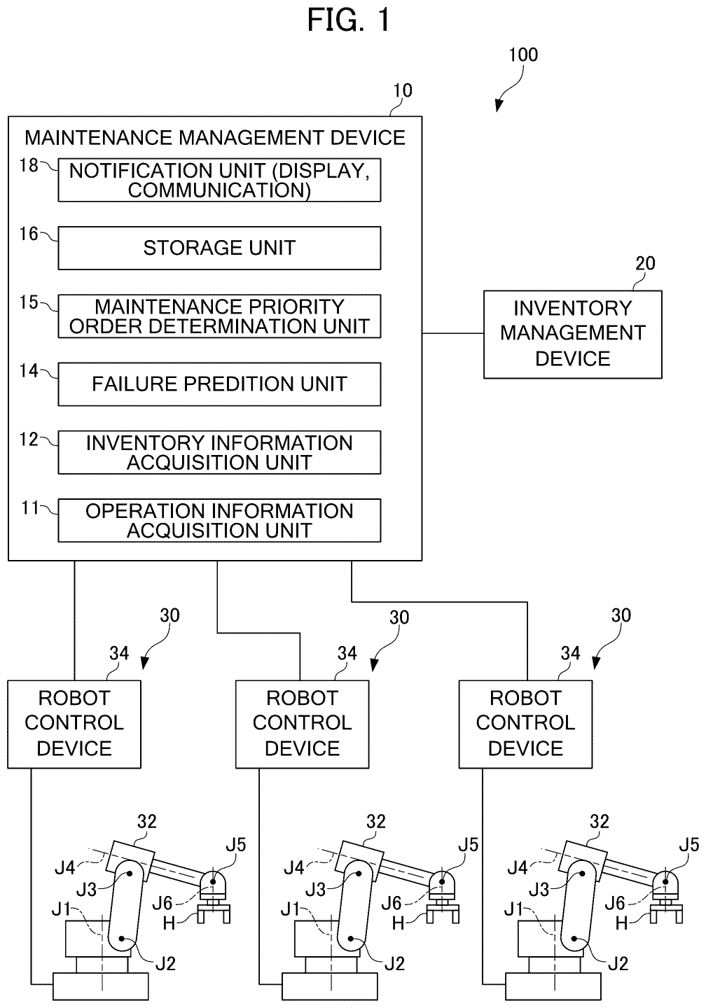

FIG. 1 shows an example of a production system including a maintenance management device for industrial machines according to the present embodiment. As shown in FIG. 1, a production system 100 includes a plurality of industrial machines 30, a maintenance management device 10, and an inventory management device 20.

Each of the industrial machines 30 includes, for example, a robot 32 and a robot control device 34. The robot 32 includes a plurality of drive shafts J1, J2, J3, J4, J5, and J6, and, for example, a hand H capable of holding a workpiece or a tool H capable of machining a workpiece is provided at the distal end of the robot 32. The robot 32 can perform a desired operation by moving the hand H or the tool H by driving the drive shafts J1 to J6. The robot 32 may be a vertical articulated robot as shown in the drawing, but is not limited thereto, and may be, for example, an orthogonal coordinate robot, a scalar robot, a parallel link robot, or the like.

The robot control device 34 controls the robot 32. Specifically, the robot control device 34 operates the robot 32 in accordance with a given work program. More specifically, the robot control device 34 may have a known configuration in which the position or the speed of each of the drive shafts J1 to J6 of the robot 32 necessary for performing the operation according to the machining program is calculated for each time, and the necessary current is applied to each of the drive shafts J1 to J6 of the robot 32. In addition, the robot control device 34 transmits the operation information including the current operation status and the past operation performance relating to the operation time of the robot 32 and the like, and the cumulative operation time to the maintenance management device 10.

The maintenance management device 10 and the inventory management device 20 may be disposed on the factory side where the industrial machines 30 are disposed, or may be disposed on the server device side connected to the industrial machines 30 via a network. Alternatively, the maintenance management device 10 may be disposed on the factory side, the inventory management device 20 may be disposed on the server device side, and the maintenance management device 10 and the inventory management device 20 may be connected via a network.

The inventory management device 20 manages the inventory and procurement of replacement components for the components of the robots 32 in the plurality of industrial machines 30. Examples of the components include a driving component (for example, a motor) of the robot 32, and a maintenance component such as a hand or a tool. The inventory management device 20 manages inventory information regarding the inventory and procurement of the replacement components as described below, for example.
Component ID
Product number and product name
Unit price
Quantity of inventory
Quantity of next order (unit)
Dates of entry and exit
Inventory date
Cumulative inventory value
Procurement lead time (time from order to delivery)
Supplier

The inventory management device 20 may notify the maintenance management device 10 of inventory information regarding the inventory and procurement of replacement components that are not in stock or low in stock, in particular, the quantity of inventory (inventory status) and the procurement lead time (procurement status). Alternatively, in response to an inquiry from the maintenance management device 10, the inventory management device 20 may transmit inventory information regarding the inventory and procurement of the inquired component, particularly the quantity of inventory (inventory status) and the procurement lead time (procurement status) to the maintenance management device 10.

The maintenance management device 10 monitors and diagnoses the plurality of industrial machines 30, and manages the maintenance (preventive maintenance and maintenance) of the plurality of industrial machines 30. Specifically, the maintenance management device 10 aggregates the operation information of the plurality of industrial machines 30, predicts failure-predicted components, which are predicted to fail among the plurality of industrial machines 30, and predicted failure times thereof based on the aggregated operation information, and determines the maintenance priority order of these failure-predicted components of the plurality of industrial machines 30 based on the predicted failure times of the failure-predicted components. At this time, the maintenance management device 10 cooperates with the inventory management device 20 to determine the maintenance priority order of the failure-predicted components based on the inventory status of the replacement components for the failure-predicted components or based on the procurement status (for example, the procurement lead times) of the replacement components for the failure-predicted components when there is no inventory. The maintenance management device 10 includes an operation information acquisition unit 11, an inventory information acquisition unit 12, a failure prediction unit 14, a maintenance priority order determination unit 15, a storage unit 16, and a notification unit 18.

The operation information acquisition unit 11 is a communication interface conforming to a known wireless or wired communication standard. The operation information acquisition unit 11 acquires the operation information of each of the industrial machines 30 from the robot control device 34 of each of the industrial machines 30. Examples of the operation information include the current operation status and the past operation performance relating to the operation time of the robot 32 of the industrial machine 30 and the like, and the cumulative operation time.

The inventory information acquisition unit 12 is a communication interface conforming to a known wireless or wired communication standard. The inventory information acquisition unit 12 is notified of inventory information regarding the inventory and procurement of replacement components that are not in stock or are low in stock from the inventory management device 20. Alternatively, the inventory information acquisition unit 12 makes an inquiry to the inventory management device 20, and acquires inventory information regarding the inventory and procurement of replacement components for the failure-predicted components predicted by the failure prediction unit 14, which will be described later, from the inventory management device 20. The inventory information acquisition unit 12 may periodically make an inquiry to the inventory management device 20 and periodically acquire the latest inventory information. Examples of the inventory information include an inventory status including the quantity of inventory of replacement components and a procurement status including the procurement lead times for replacement components.

The failure prediction unit 14 and the maintenance priority order determination unit 15 each include, for example, an arithmetic processor such as a CPU (central processing unit), a DSP (digital signal processor), or an FPGA (field-programmable gate array). Various functions of the failure prediction unit 14 and the maintenance priority order determination unit 15 are realized by executing predetermined software (programs) stored in the storage unit 16, for example. Various functions of the failure prediction unit 14 and the maintenance priority order determination unit 15 may be realized by cooperation of hardware and software, or may be realized only by hardware (electronic circuits).

The storage unit 16 is, for example, a memory such as a ROM (read only memory), a HDD (hard disk drive), or a SSD (solid state drive). The storage unit 16 stores predetermined software (programs) for executing various functions of the failure prediction unit 14 and the maintenance priority order determination unit 15 described above. The storage unit 16 may temporarily store the operation information acquired by the operation information acquisition unit 11 and the inventory information acquired by the inventory information acquisition unit 12. The storage unit 16 may temporarily store the failure-predicted components and the predicted failure times thereof predicted by the failure prediction unit 14, and the maintenance priority order determined by the maintenance priority order determination unit 15.

The failure prediction unit 14 predicts failure-predicted components, which are predicted to fail among the components of the plurality of industrial machines 30, and predicted failure times thereof based on the operation information acquired by the operation information acquisition unit 11.

Here, for example, with regard to a maintenance component such as a hand or a tool, there is a recommended operation time according to supplier recommendation or past use performance. Therefore, for example, the failure prediction unit 14 predicts a failure and a failure time of a maintenance component such as a hand or a tool based on the cumulative operation time.

The maintenance priority order determination unit 15 determines the maintenance priority order of the failure-predicted components of the plurality of industrial machines 30 based on the predicted failure times of the failure-predicted components predicted by the failure prediction unit 14 and the inventory information of the replacement components acquired by the inventory information acquisition unit 12.

For example, the maintenance priority order determination unit 15 determines the maintenance priority order of the failure-predicted components of the plurality of industrial machines 30 mainly based on the predicted failure times. Here, even if there is no inventory of a replacement component, if the lead time for procurement of the replacement component is relatively short, the inventory of the replacement component can be secured before maintenance. On the other hand, if the lead time for procurement of a replacement component is relatively long, the inventory of the replacement component may not be secured until maintenance, and the date of maintenance needs to be adjusted. Therefore, when there is no inventory of a replacement component and the lead time for procurement of the replacement component is longer than a predetermined value, the maintenance priority order determination unit 15 lowers the maintenance priority order of the failure-predicted component.

For example, when the maintenance management device 10 is disposed on the factory side where the industrial machines 30 are disposed, the notification unit 18 may be a display device such as a liquid crystal display or an organic EL display. The notification unit 18 displays (notifies) the maintenance priority order of the failure-predicted components of the plurality of industrial machines 30 determined by the maintenance priority order determination unit 15. In addition, the notification unit 18 may display (notify) the failure-predicted components of the plurality of industrial machines 30 and the predicted failure times predicted by the failure prediction unit 14. When the inventory information of a replacement component acquired from the inventory management device 20 indicates a shortage of inventory, the notification unit 18 may display (notify) information regarding the shortage of inventory.

Alternatively, for example, when the maintenance management device 10 is disposed on the server device side connected to the industrial machines 30 via a network, the notification unit 18 may be a communication interface conforming to a known wireless or wired communication standard. The notification unit 18 transmits (notifies) the maintenance priority order of the failure-predicted components of the plurality of industrial machines 30 determined by the maintenance priority order determination unit 15 to the factory side where the industrial machines 30 are disposed via the Internet. Thus, on the factory side, the maintenance priority order of the failure-predicted components can be displayed on a display device such as a liquid crystal display or an organic EL display. In addition, the notification unit 18 may transmit (notify) the failure-predicted components of the plurality of industrial machines 30 and the predicted failure times predicted by the failure prediction unit 14 to the factory side where the industrial machines 30 are disposed via the Internet. Accordingly, on the factory side, for example, the failure-predicted components and the predicted failure times can be displayed on the display device, for example. When the inventory information of a replacement component acquired from the inventory management device 20 indicates a shortage of inventory, the notification unit 18 may transmit (notify) information regarding the shortage of inventory to the factory side where the industrial machines 30 are disposed via the Internet. As a result, on the factory side, the information regarding the shortage of inventory of the replacement component can be displayed on the display device, for example.

As described above, according to the maintenance management device 10 of the present embodiment, the operation information of the plurality of industrial machines 30 is aggregated, failure-predicted components, which are predicted to fail among the plurality of industrial machines 30, and the predicted failure times thereof are predicted based on the aggregated operation information, and the maintenance priority order of the failure-predicted components of the plurality of industrial machines 30 is determined based on the predicted failure times of the failure-predicted components. At this time, the maintenance management device 10 cooperates with the inventory management device 20 to determine the maintenance priority order of the failure-predicted components based on the inventory status of replacement components for the failure-predicted components or based on the procurement status (for example, the procurement lead times) of the replacement components for the failure-predicted components when there is no inventory. As described above, according to the maintenance management device 10 of the present embodiment, it is possible to perform maintenance management of the industrial machines in consideration of the inventory status of the replacement components.

In addition, according to the maintenance management device 10 of the present embodiment, the maintenance priority order of the failure-predicted components of the plurality of industrial machines 30 determined by the maintenance priority order determination unit 15 may be notified, the failure-predicted components of the plurality of industrial machines 30 and the predicted failure times predicted by the failure prediction unit 14 may be notified, and the information regarding the shortage of inventory of the replacement component acquired from the inventory management device 20 may be notified. As a result, even when there is no inventory of a replacement component and the lead time for procurement of the replacement component is long, it is possible to reduce failure of the failure-predicted component before maintenance.

Although the embodiment of the present invention has been described above, the present invention is not limited to the above-described embodiment, and various changes and modifications can be made. For example, in the above-described embodiment, a mode in which a robot is included as an industrial machine has been exemplified, but the industrial machine may have various modes. That is, in the above-described embodiment, the maintenance management of the components of the robot is exemplified, but the present invention is not limited thereto, and can be applied to the maintenance management of components of various industrial machines such as machine tools.

### EXPLANATION OF REFERENCE NUMERALS

10 maintenance management device
11 operation information acquisition unit
12 inventory information acquisition unit
14 failure prediction unit
15 maintenance priority order determination unit
16 storage unit
18 notification unit
20 inventory management device
30 industrial machine
32 robot
34 robot control device
100 industrial system

1. A maintenance management device for industrial machines, for managing maintenance of a plurality of industrial machines, the maintenance management device comprising:
an operation information acquisition unit configured to acquire operation information of the plurality of industrial machines;
a failure prediction unit configured to predict a failure-predicted component, which is predicted to fail among components of the plurality of industrial machines, and a predicted failure time of the failure-predicted component based on the acquired operation information;
an inventory information acquisition unit configured to acquire inventory information regarding inventory and procurement of replacement components for the components of the plurality of industrial machines; and
a maintenance priority order determination unit configured to determine a maintenance priority order of the failure-predicted component of the plurality of industrial machines based on the predicted failure time of the failure-predicted component and the acquired inventory information of the replacement components.

2. The maintenance management device for industrial machines according to claim 1, wherein the inventory information acquisition unit is notified of inventory information regarding inventory and procurement of a replacement component that is not in stock or low in stock.

3. The maintenance management device for industrial machines according to claim 1, wherein the inventory information acquisition unit acquires inventory information regarding inventory and procurement of a replacement component for the failure-predicted component.

4. The maintenance management device for industrial machines according to claim 1,
wherein the inventory information includes an inventory status including a quantity of inventory of each of the replacement components and a procurement status including a procurement lead time of each of the replacement components, and
wherein, when there is no inventory of a replacement component and the procurement lead time of the replacement component is longer than a predetermined value, the maintenance priority order determination unit lowers the maintenance priority order of the failure-predicted component.

5. The maintenance management device for industrial machines according to claim 1,
wherein the operation information includes a cumulative operation time of each of the plurality of industrial machines, and
wherein the failure prediction unit predicts the failure-predicted component and the predicted failure time thereof based on the cumulative operation time.

6. The maintenance management device for industrial machines according to claim 1, further comprising a notification unit configured to notify the determined maintenance priority order.

7. A production system, comprising:
a plurality of industrial machines;
the maintenance management device for industrial machines according to claim 1; and
an inventory management device configured to manage inventory and procurement of replacement components for components of the plurality of industrial machines.
